(19) United States
(12) Patent Application Publication
(10) Pub. No.: US 2021/0394533 A1
(43) Pub. Date: Dec. 23, 2021

(54) PRINTERS

(71) Applicant: Hewlett-Packard Development Company, L.P., Spring, TX (US)

(72) Inventors: Antonio Monclus Velasco, Sant Cugat del Valles (ES); Francisco Guerrero Carvajal, Sant Cugat del Valles (ES); Diego Lopez Ubieto, Sant Cugat del Valles (ES); Alberto Borrego Lebrato, Sant Cugat del Valles (ES)

(73) Assignee: Hewlett-Packard Development Company, L.P., Spring, TX (US)

(21) Appl. No.: 17/259,577

(22) PCT Filed: Mar. 13, 2019
(86) PCT No.: PCT/US2019/022123

§ 371 Date: Jan. 12, 2021

(51) Int. Cl. B41J 11/04; B41J 3/407

(52) U.S. Cl. CPC B41J 11/04; B41J 3/4078

(57) ABSTRACT

Example implementations relate to printers for printing a printing liquid on a medium, the printer having a media path for the medium; the media path comprising a print platen for receiving the medium from an input media carrier and for outputting the medium to an output media carrier; the media path also comprising a spread roller disposed between the print platen and the output media roller, and the print platen having an associated arcuate surface for orientating the medium towards the spread roller.

Commercial printers and, in particular, large-format printers are printer that accommodate to several types of medias. When using so-called thin materials, e.g., on digital textile printing several challenges are to be overcome. In the textiles digital large format printing business, using transfer paper in dye sublimation printing is highly widespread. When using thin transfer paper such as, for example, transfer paper having a density of less than 70 grams/m2, in large format printers such as, for example, printers having a width of about 3.2 metres, controlling the print medium is challenging. For example, in industrial roll-to-roll printers, the medium leaves the print-zone to be accumulated on an output roll guided by a roller or diverter wheels that can lead to wrinkling of the medium where there is a change in the direction of the media path.

### BRIEF DESCRIPTION OF THE DRAWINGS

Example implementations will now be described with reference to the accompanying drawings in which:

FIG. 1 shows a printer according to example implementations;

FIG. 2 illustrates a curved print platen according to example implementations;

FIG. 3 depicts a further view of the curved print platen according to example implementations;

FIG. 4 shows a view of ribs of the curved print platen according to example implementations;

FIG. 5 illustrates a plan view of the ribs depicted in FIG. 4 according to example implementations; and

FIG. 6 depicts a plan view of the ribs shown in FIG. 4 according to example implementations.

### DETAILED DESCRIPTION

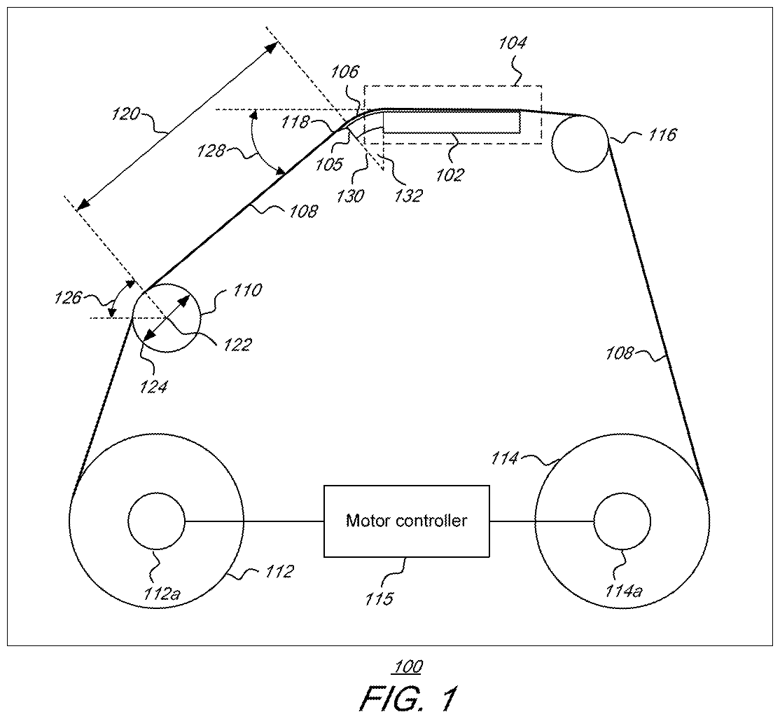

Referring to FIG. 1, there is shown a schematic view of a printer 100. The printer 100 comprises a medium path. The medium path comprises a print platen 102 within a print zone 104. The print platen 102 has an associated curved print platen 105 having an arcuate or curved surface 106. The arcuate surface 106 is arranged to facilitate a progressive change in direction of a medium 108 leaving the print platen 102. Although the example implementation depicted shows the print platen 102 and the curved print platen 105 as separate entities, example implementations are not limited to such an arrangement. Example implementations can be realised in which the print platen 102 and the curved print platen 105 are a unitary structure, with the curved portion of the print platen of such a unitary structure corresponding in function to the above curved print platen 105.

After leaving the arcuate surface 106, the medium 108 is guided by a spread roller 110 before being fed to an output medium roller 112. Such an output roller 112 is an example implementation of an output medium carrier. Therefore, the progressive change in direction is arranged to orientate the medium 108 progressively towards the spread roller 110. The medium 108 is initially stored or loaded on an input medium roller 114. Such an input roller 114 is an example implementation of an input medium carrier.

Therefore, it can be appreciated that the medium 108 follows a predetermined path, known as the media path, through the printer 100. Optionally, a drive roller 116 can be provided to facilitate a transition of the medium 108 from the input medium roller 114 onto the print platen 102.

The input 114 and output 112 medium rollers can be controlled by respective motors 112a and 114a that are arranged to maintain the medium 108 in a predetermined state. The predetermined state can comprise, for example, a predetermined degree of tension. The predetermined degree of tension can be a predetermined tension in the range of 20 N/m of medium to 90 N/m of medium, that is, 20 N per metre width of the medium to 90 N per metre width of the medium. For example, in the case of a 3.2 m medium width, the tension would be in the range of 64 N to 288 N. The motors 112a and 114a are responsive to a motor controller 115. At least one or more than one of the motors 112a, 114a or motor controller 115, taken jointly and severally in any and all permutations, can constitute, at least in part, a tensioner that is, or can be, arranged to maintain the medium under a predetermined tension.

The arcuate surface 106 is arranged to facilitate a change in direction of the medium 108 relative to its direction of travel on the print platen 102 by a predetermined angle. Example implementations can be realised in which the predetermined angle is, for example, 40 degrees. However, example implementations are not limited to such a predetermined angle. Examples can be realised in which the predetermined angle is some other angle such as, for example, 35 degrees to 45 degrees, or any angle in between 35 degrees to 45 degrees.

The spread roller 110 is disposed in a predetermined relationship relative to an end or exit point 118 of the arcuate surface 106. Example implementations can be realised in which the predetermined relationship is such that the spread roller 110 is at a predetermined distance 120 from the end or exit point 118 of the arcuate surface 106. Example implementations can be realised in which the distance 120 between the centre, or axis, of rotation 122 of the spread roller 110 and the exit or end point 118 of the arcuate surface 106 is related to the diameter 124 of the spread roller 110. For example, such a distance 120 between the axis of rotation 122 of the spread roller 110 and the exit or end point 118 of the arcuate surface 106 can be a predetermined multiple of the diameter 124 of the spread roller 110. Example implementations can be realised in which the distance 120 between the axis of rotation 122 of the spread roller 110 and the end or exit point 118 of the arcuate surface 106 is between 3 and 6 times the diameter 124 of the spread roller 110. Example implementations can be realised in which that distance 120 is 3 to 4, or 5, times the diameter 124 of the spread roller 110.

The spread roller 110, the arcuate surface 106 and the output medium roller 112 are arranged in a predetermined relationship. Example implementations can be realised in which the predetermined relationship is such that the contact point or contact area of the medium 108 with the spread roller 110 subtends a predetermined angle 126, known as the wrap-angle. Example implementations can be realised in which the wrap-angle is between 15 degrees and 90 degrees inclusive such as, for example, 20 degrees or greater than 20 degrees.

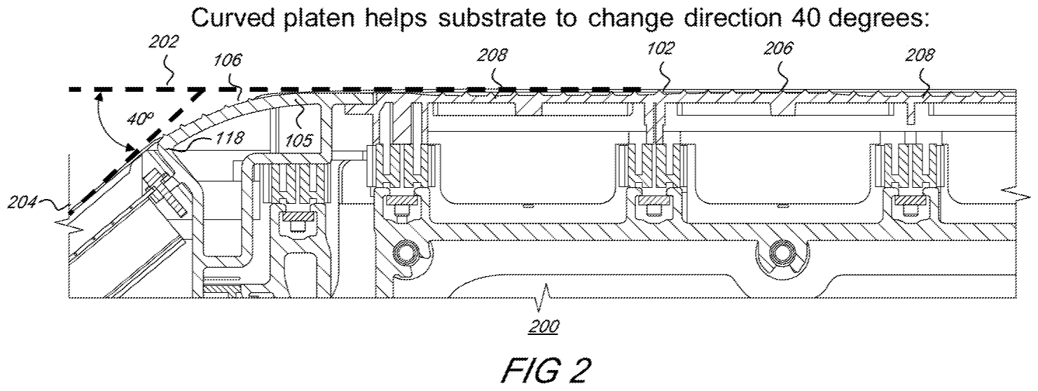

Referring to FIG. 2, there is shown a sectional view 200 of the print platen 102 and the associated arcuate or curved print platen 105. It can be appreciated that the upper surface of the print platen 102 falls within, or is coplanar with, a respective plane 202. The end or exit point 118 of the curved print platen 105 has a respective tangent 204. The angle 128 between the respective plane 202 and the tangent 204 is a predetermined angle such as, for example, an angle that is between 35 and 45 degrees and, optionally, the predetermined angle can be 40 degrees. The surface 106 of the curved print platen 106 and the print platen 102 are tangential to one another. A smooth transition between the print platen 102 and the surface 106 of the curved print platen 105 facilitates reducing, or eliminating, anomalies in the medium such as, for example, wrinkling or other distortions.

The curved platen 105 has a predetermined radius of curvature 130. The radius of curvature is between 80 mm and 90 mm inclusive. Example implementations herein can be realised using a radius of curvature 130 of 84 mm. Furthermore, the surface 106 of the curved print platen 105 subtends a predetermined angle 132. The predetermined angle 132 can be between 30 degrees and 50 degrees inclusive. Example implementations can be realised in which the predetermined angle 132 is 40 degrees.

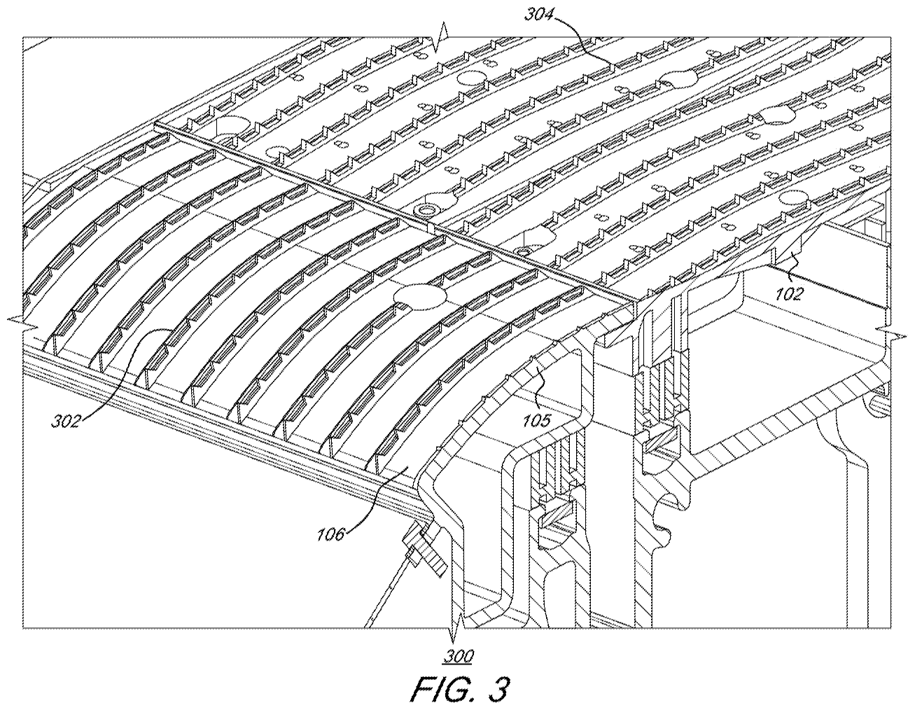

The print platen 102 can have a non-planar upper surface. In the example implementations shown, the sectional view of the upper surface, along a linear section, has the appearance of undulations, that is, peaks 206 and troughs 208, due to non-linear formations described below with reference to FIG. 3. The plane 202 is also tangential to the upper surface of the arcuate or curved print platen 106.

Referring to FIG. 3, there is depicted a sectional view 300 of the print platen 102, that is, the planar-print platen 102, and the arcuate print platen 105. The arcuate print platen 105 bears a number of formations 302 on the upper surface 106 of the arcuate print platen 105. The formations 302 can be non-linear. An example of such a formation 302 can be realised in the form of a rib. The rib can be a non-linear rib. Example implementations can be realised in which the ribs have a respective upper surface and cross-sectional profile. The ribs 302 are arranged to facilitate guiding the medium, or facilitating a change in direction of the medium, from the plane 202 of the upper surface of the print platen 102 through a predetermined angle such as, for example, the above mentioned 35 to 45 degrees or, optionally, 40 degrees, to direct the medium 108 towards the spread roller 110. The number of formations is an example implementation of a number of features.

The print platen 102 also has corresponding formations 304 such as those described with reference to the surface 106 of the curved print platen 105. Again, it can be appreciated that the upper surface of the print platen 102 bears a non-linear profile.

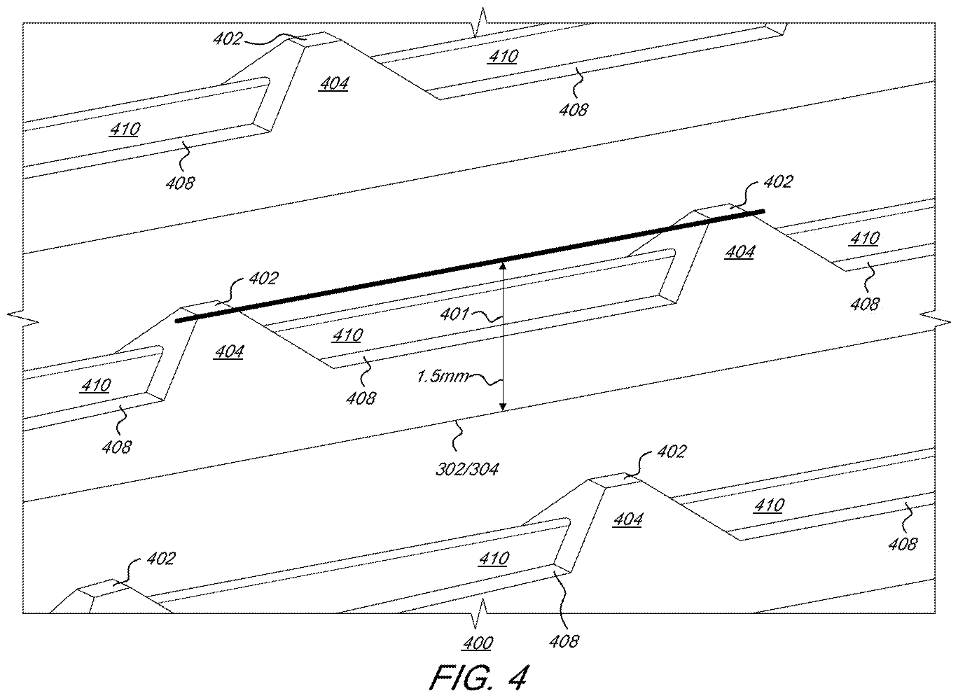

Referring to FIG. 4, there is shown a view 400 of an example implementation of a rib such as one, or both, of the above described ribs 302 and 304. It can be appreciated that the rib 302/304 has a predetermined height 401. Example implementations can be realised in which the predetermined height is between 0.75 and 1.175 mm such as, for example, 1.5 mm.

A rib bears a number of formations. It can be appreciated that the formations can comprise a plurality of lands 402. The lands 402 have predetermined dimensions. Example implementations can be realised in which the lands 402 are rectangular. Example implementations can be realised in which the lands 402 have dimensions of 0.5 mm by 0.5 mm.

Example implementations can be realised in which the ribs reduce, or influence, the frictional coupling between the ribs and the medium. Alternatively, or additionally, the ribs can be arranged according to a specific frequency or spacing to control the medium expansion/contraction processes that take place when the medium 108 gets wet due to one or more than one substance such as, for example, one or more than one printing liquid being deposited on the medium. The one or more than one printing liquid can be, or comprise, one or more than one printing ink. Furthermore, the surfaces on which the back of the medium lies, that is, the lands 402, are reduced, or are small, which, in turn, reduces heat transfer to the medium 108, reduces heat generation due to friction between the medium and the platen or other heat transfer to the medium from the platen. Managing the heat generated or transferred assists in maintaining dimensional stability of the medium and can also assist in maintaining or influencing the temperature of the medium. Therefore, the medium can be more homogeneous in terms of temperature, which helps avoid image quality issues.

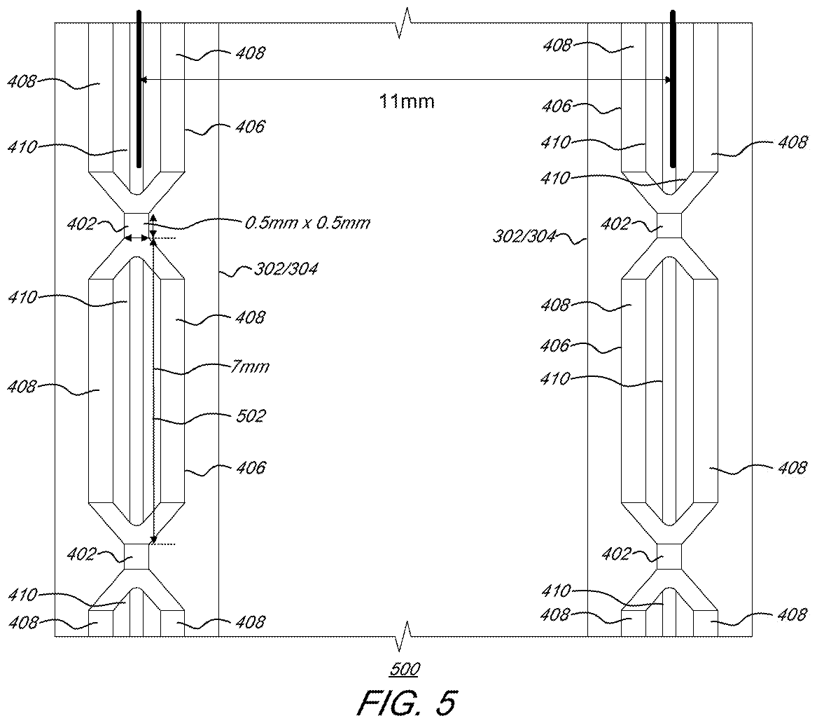

The lands 402 form part of a frusto-pyramid 404. In between each frusto-pyramid 404 the ribs bear a lower profile section 406 as can be seen in FIG. 5, which shows a plan view 500 of the ribs 302 and 304. The lower profile section 406 itself bears a pair of further lands 408 disposed either side of a spine 410 having a respective cross-sectional profile. The respective cross-sectional profile of the spine 410 can be triangular. A predetermined distance 502 is provided between adjacent or consecutive lands 402. Example implementations can be realised in which the predetermined distance 502 falls within a predetermined range. The predetermined range can be between 5 mm and 9 mm inclusive. Example implementations can be realised in which the predetermined distance 502 is 11 mm.

The ribs are profiled to influence, or reduce, the frictional coupling between the medium 108 and at least one, or both, of the curved or arcuate surface 106 of the curved print platen 105 or the substantially planar-print platen 102. The general sectional profile of a rib can be triangular.

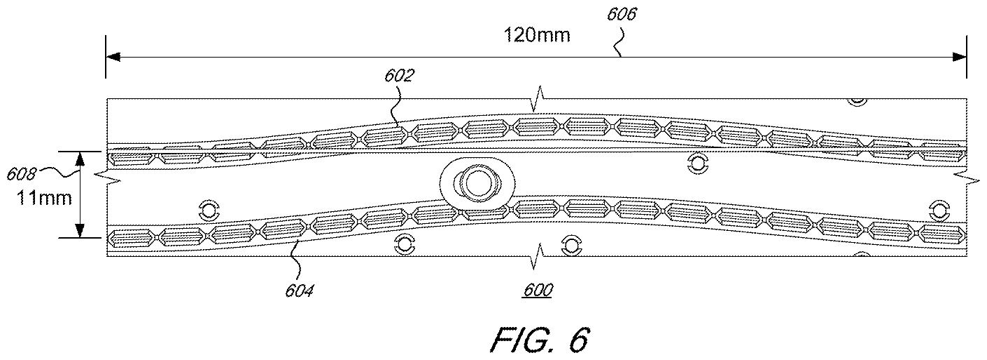

Referring to FIG. 6, there is shown a view 600 of a pair of ribs 602, 604. The pair of ribs 602, 604 can be any adjacent ribs of the ribs described in this application. Example implementations can be realised in which the ribs are non-linear. Example implementations can be realised in which the ribs are arcuate. Example implementations can be realised in which the ribs bear one or more than one periodic feature. Such a periodic feature can be, for example, a wave, sinusoidal, arcuate or other curved shape. The periodic feature can be, or have, a predetermined wavelength 606. Such non-linear ribs vary the point of contact with the medium. Varying the point of contact between the ribs and the medium mitigates the effects of contact with the medium in substantially the same place that follows from, for example, linear ribs or supports. For example, the medium can be marked or otherwise damaged by contact in substantially the same place. The non-linear features are arranged to vary within plane of the upper surface of at least one, or both, of the print platen 102 or the arcuate or curved print platen 105. Example implementations can be realised in which the non-linear ribs have a predetermined wavelength such as, for example, between 110 mm and 125 mm such as, for example, 120 mm.

Furthermore, example implementations can be realised in the ribs 602 and 604, or other formations 302, have a predetermined frequency or spacing 608. The predetermined frequency or spacing 608 can be between a predetermined range such as, for example, between 5 mm and 25 mm, or between 10 mm and 20 mm such as, for example, between 9 mm and 13 mm. Example implementations can be realised in which the predetermined frequency or spacing 608 is 11 mm.

Example implementations can be realised according to the following clauses:

Clause 1: A printer for printing a printing liquid, such as, for example, an ink, on a medium, the printer having a medium path for the medium; the medium path comprising a print platen for receiving the medium from an input media carrier and for outputting the medium to an output media carrier; the media path also comprising a spread roller disposed between the print platen and the output media roller, and the print platen having an associated arcuate or curved surface for orientating the medium towards the spread roller.

Clause 2: The printer of clause 1, in which the associated arcuate or curved surface comprises a number of features arranged to influence movement of the medium. The movement of the medium can be in response to a change in a characteristic of the medium, such as, for example, expansion due to ink absorption.

Clause 3: The printer of clause 2, in which the number of features comprises a number of ribs.

Clause 4: The printer of either of clauses 2 and 3, in which the number of features have a predetermined frequency or spacing.

Clause 5: The printer of clause 4, in which the predetermined frequency or spacing is a predetermined number of millimeters.

Clause 6: The printer of clause 5, in which the predetermined frequency or spacing is between 5 mm and 25 mm, such as, for example, 10 mm or 20 mm such as, for example, 11 mm.

Clause 7: The printer of any of clauses 4 to 6, in which the predetermined frequency or spacing is associated with the density of the medium such as, for example, 45g/m² to 100 g/m², optionally less than 70 g/m².

Clause 8: The printer of any preceding clause, in which the arcuate or curved surface is disposed in a predetermined relationship with the spread roller.

Clause 9: The printer of any preceding clause, in which the arcuate or curved surface is spaced apart from the spread roller by a distance associated with the diameter of the spread roller such as, for example, 4 to 5 times the diameter of the spread roller.

Clause 10: The printer of any preceding clause, in which the spread roller is positioned at a predetermined angle relative to the arcuate or curved surface such as, for example, 40 degrees.

Clause 11: The printer of any preceding clause, in which the medium is a transfer paper.

Clause 12: The printer of any preceding clause, in which the arcuate or curved surface subtends a predetermined number of degrees.

Clause 13: The printer of clause 12, in which the predetermined number of degrees is less than 15 degrees, optionally less than 10 degrees.

Clause 14: The printer of any preceding clause, comprising a tensioner arranged to maintain the medium under a predetermined tension.

Clause 15: The printer of clause 14, in which the predetermined tension is in the range of 20 N/m of medium to 90 N/m of medium.

Clause 16: The printer of any preceding clause, in which the exit angle of the curved or arcuate surface of the print platen, the spread roller and the output media roller are disposed so that the medium in contact with the spread roller subtends an angle, known as a wrap angle, of greater than 20 degrees.

Clause 17: The printer of any of clauses 1 to 16, in which the associated arcuate or curved surface comprises a number of features arranged to influence movement of the medium. Influencing movement of the medium can be in response to a change in a characteristic of the medium, such as, for example, expansion due to ink or printing liquid absorption.

Clause 18: The printer of clause 17, in which the number of features comprise non-linear features.

Clause 19: The printer of either of clauses 17 and 18, in which the number of features bear one or more than one periodic feature.

Clause 20: The printer of clause 19, in which the one or more than one periodic feature is a predetermined wavelength.

Clause 21: The printer of clause 20, in which the predetermined wavelength is 120 mm.

What is claimed is:

1. A printer for printing a printing liquid on a medium, the printer having a media path for the medium; the media path comprising a print platen for receiving the medium from an input media carrier and for outputting the medium to an output media carrier; the media path also comprising a spread roller disposed between the print platen and the output media roller, and the print platen having an associated arcuate surface for orientating the medium towards the spread roller.

2. The printer of claim 1, in which the associated arcuate surface comprises a number of features arranged to influence movement of the medium.

3. The printer of claim 2, in which the number of features comprises a number of ribs.

4. The printer of claim 2, in which the number of features have a predetermined frequency or spacing.

5. The printer of claim 4, in which the predetermined frequency or spacing is a predetermined number of millimeters.

6. The printer of claim 5, in which the predetermined frequency or spacing is between 5 mm and 25 mm.

7. The printer of claim 5, in which the predetermined frequency or spacing is 11 mm.

8. The printer of claim 1, in which the arcuate surface is disposed in a predetermined relationship with the spread roller.

9. The printer of claim 8, in which the predetermined relationship is such that the arcuate surface is spaced apart from the spread roller by a distance associated with the diameter of the spread roller.

10. The printer of claim 8, in which the spread roller is positioned at a predetermined angle relative to the arcuate surface.

11. The printer of claim 1, in which the arcuate surface subtends a predetermined number of degrees.

12. The printer of claim 11, in which the predetermined number of degrees is less than 15 degrees.

13. The printer of claim 1, comprising a tensioner arranged to maintain the medium under a predetermined tension.

14. The printer of claim 1, in which the exit angle of the curved surface of the print platen, the spread roller and the output media roller are disposed so that the medium in contact with the spread roller subtends a predetermined angle.

15. The printer of claim 14, in which the predetermined angle is greater than 20 degrees.
